(19) United States
(12) Patent Application Publication
(10) Pub. No.: US 2006/0082175 A1
(43) Pub. Date: Apr. 20, 2006

(54) AUTOMOTIVE TRIM PART WITH MULTI-FEEL COVER AND METHOD OF MAKING THE SAME

(76) Inventors: Glenn A Cowelchuk, Chesterfield Township, MI (US); Todd L DePue, Brighton, MI (US); David Dooley, Troy, MI (US); Michael J Hier, Milford, MI (US); Randy S Reed, Fair Haven, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/904,010

(22) Filed: Oct. 19, 2004

(51) Int. Cl. B60N 2/46

(52) U.S. Cl. 296/1.09

(57) ABSTRACT

The present invention provides for an improved trim part with a multi-feel cover for use in a trim assembly, e.g. a door panel, and to a continuous two-shot molding operation that may be performed utilizing a single mold assembly. In an exemplary embodiment, a trim assembly includes a substrate having an integrated armrest and/or integrated bolster formed by injecting a first material into a first shot mold cavity in a first shot of a molding operation. A cover then is molded to at least a portion of the integrated trim part by injecting into a mold chamber a second foamed material in a second shot of the molding operation. The molded cover defines a first and second thickness with the second thickness being greater than the first thickness to provide a softer feel. The second foamed material produces an outer skin and a light, cellular inner core, within at least the second thickness of the cover, such that the skin deforms and compresses the inner core when a force is applied thereby providing a softer feel.

### FIELD OF THE INVENTION

The present invention pertains generally to trim assemblies for automotive interiors and, more particularly, to trim parts having a multi-feel cover for use in trim assemblies, and to a method of making the same.

### BACKGROUND OF THE INVENTION

It is known to provide automotive interiors with various trim assemblies to enhance the aesthetic appearance of the automotive interior and to provide comfort, as well as convenience, to vehicle occupants. Examples of these interior trim assemblies include instrument panels, door panels, and consoles. To increase the aesthetic appearance of the trim assemblies and to improve the comfort to vehicle occupants, it is desired to provide at least portions or parts, such as the armrest or bolster, of the trim assemblies with areas that are more, or less, cushy or soft to the touch than other areas.

One primary drawback with current bolsters and armrests is in the manufacturing and assembly thereof. Specifically, these trim parts typically have been formed by insertion of a resilient soft padding material beneath a pliable surface or skin layer of decorative trim material, such as a textile or fabric like woven cloth, vinyl, and/or leather. The preformed, soft, resilient pad also may be secured to a rigid plastic shell and a pliable skin layer stretched over the pad and secured to the shell to form a trim assembly with soft feel armrest and/or bolster. In other cases, the soft padding has been omitted to provide merely the trim material that may be adhesively bonded thereto. In another conventional method of forming trim assemblies with padded areas, a foam material may be injected between a rigid substrate and a skin layer joined to the substrate. These methods are generally costly due to the multiple components and manufacturing steps required to make them.

In addition, thick skin layers having bumps or nibs formed on the B-side, or back surface, thereof have been applied over rigid substrates in an effort to improve the feel of non-padded armrests and bolsters. These nibs raise the skin layer slightly away from the rigid substrate to create “soft” areas that deform when a force is applied to the trim assembly. As such, the nib design, not the skin material per se, provides for the soft areas. Also, while these nibbed trim assemblies offer a compromise between padded trim assemblies, they are costly due to the fact that the skin layer must be manufactured separately in order to create the bumps or nibs.

There is thus a need for an improved trim part, such as an armrest or bolster, with a multi-feel cover for use in a trim assembly, and a method for making the same, that reduces the number of parts and the labor required for assembly thereof thereby reducing overall manufacturing costs.

### SUMMARY OF THE INVENTION

The present invention provides for an improved trim part with multi-feel cover for use in a trim assembly, e.g. a door trim panel or console panel.

To this end, a trim assembly, such as a door trim assembly, includes a substrate having a trim part, such as an armrest and/or bolster, advantageously an integrated trim part. A bolster may cover an access opening defined in the trim panel such that when the bolster is removed, a technician or assembly line worker can access the space between the trim panel and the inner door panel to install or service the door components and their drive mechanisms. In other cases, the bolster may be permanently secured, such as by gluing, or integrally molded thereto so that an access opening cannot be exposed by removing the bolster.

The trim part can be made from a first material that may include a thermoplastic polymer such as a thermoplastic olefin, e.g. polypropylene, or polycarbonate/acrylonitrile butadiene styrene. A cover is integrally molded to at least a portion of the trim part, i.e. the armrest and/or bolster, to define at least a first and a second thickness. The second thickness is greater than the first thickness to provide a multi-feel cover, i.e. a softer feel at the second thickness. The second foamed material may be a foamed thermoplastic polymer such as a foamed thermoplastic elastomer or foamed polypropylene. The second foamed material is activated, or foamed, by a blowing agent, such as sodium bicarbonate, nitrogen, or any other commonly known blowing agent.

The foamed material produces a lightweight cover that includes an outer skin and a cellular inner core, within at least the second thickness of the cover, such that the outer skin deforms and compresses the inner core when a force is applied thereby providing a softer feel to the trim part. Notably, the feel of the cover may be varied, or adjusted, to any desired softness by changing the thickness thereof with the second thickness of the cover advantageously being at least 2 times greater than the first thickness of the cover. At a thickness of about 1.5 mm or less, the cover defines an outer skin but is substantially devoid of a soft inner core because of an inability of the core to be foamed. As such, the first thickness of the armrest cover advantageously is about 1-3 mm and the second thickness is about 5-12 mm.

In another embodiment, the trim assembly includes the substrate provided with the trim part, advantageously an integrated trim part, such as an armrest and/or bolster, wherein the trim part includes an outer surface and a recessed area. The multi-feel cover is integrally molded to at least a portion of the outer surface to define the first thickness and further is integrally molded within the recessed area to define the second thickness. Accordingly, the second thickness is greater than the first thickness to provide a multi-feel cover, i.e. a softer feel at the second thickness.

The automotive trim part, i.e. armrest and/or bolster, with multi-feel cover is formed in a continuous two-shot molding process. In this operation, a mold assembly is provided in which a trim part, advantageously a door trim panel having an integrated trim part, is formed by injecting the first material into a first shot mold cavity in a first shot of the molding operation. A core of the mold assembly is used, advantageously rotated, to move the trim part from the first shot mold cavity to a second shot mold cavity, and a mold chamber is formed about at least a portion of the trim part within the second shot mold cavity.

The cover then is integrally molded thereover by injecting into the mold chamber the second foamed material in a second shot of the molding operation, the cover being molded to the portion of the trim part to define at least a first and a second thickness. Accordingly, the second thickness is greater than the first thickness to provide a multi-feel cover, i.e. a softer feel at the second thickness. In an exemplary embodiment, the mold assembly for forming the trim part with multi-feel cover includes first and second shot mold cavities and a rotatable core having first and second male portions adapted to mate with each cavity for forming a plurality thereof in a continuous manner.

By virtue of the foregoing, there is thus provided an improved trim part, such as an armrest and/or bolster, with a multi-feel cover for use in a trim assembly, and a method of making the same, that reduces the number of parts and the labor required for assembly thereof thereby reducing overall manufacturing costs.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automotive interior trim assembly having an armrest and bolster with multi-feel cover according to the present invention;

FIG. 1A is a cross-sectional view of FIG. 1 taken along the lines 1A-1A;

FIG. 1B is a cross-sectional view of another embodiment of an automotive interior trim assembly having an armrest and bolster with multi-feel cover;

FIG. 2 is a perspective view of a mold assembly used to form the armrest and bolster with multi-feel cover of FIG. 1;

FIG. 2A is a cross-sectional view of the mold of FIG. 2 taken along the line 2A-2A illustrating the first shot of the molding operation;

FIG. 3 is a perspective view of the mold assembly of FIG. 2 depicting the rotational movement from the first shot mold cavity to the second shot mold cavity of the formed trim part of FIG. 2A; and

FIG. 3A is a cross-sectional view of the mold of FIG. 3 taken along the line 3A-3A illustrating the second shot of the molding operation.

### DETAILED DESCRIPTION

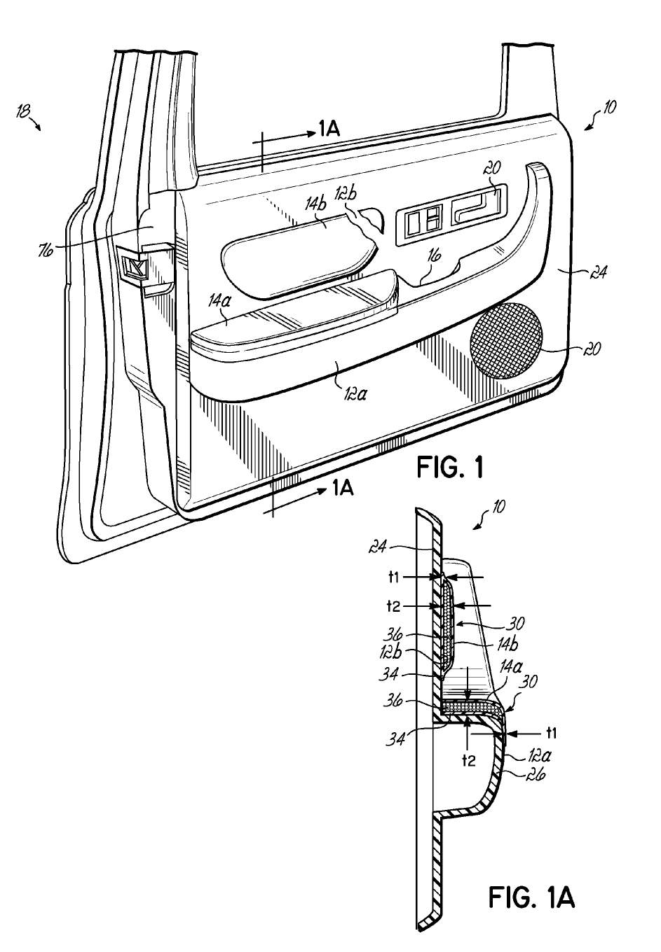

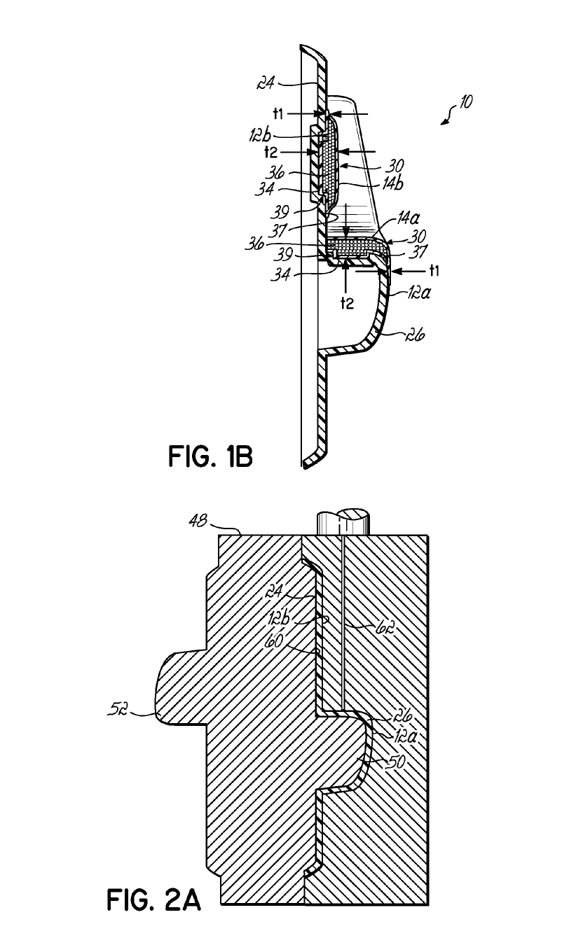

In FIG. 1, an embodiment of an automotive interior trim assembly, i.e. a door trim panel 10, for an automobile (not shown) includes an integrated trim part, i.e. an integrated armrest 12a and bolster 12b, with multi-feel covers 14a and 14b. It should be understood that the armrest 12a and bolster 12b with multi-feel covers 14a, 14b, although illustrated and described herein as being integrated, may be molded by the methods disclosed below and provided as a separate trim part for attachment to the door trim panel 10. It is further understood that only one trim part, i.e. the armrest 12a or bolster 12b, need be provided with the multi-feel cover 14a, 14b. In addition, other various trim assemblies, such as consoles, incorporating trim parts, such as armrests, generally may be constructed in a similar fashion. Thus, while the following detailed description focuses on the door trim panel 10 having the integrated armrest 12a and bolster 12b with multi-feel covers 14a, 14b, those having ordinary skill in the art will recognize that other trim parts with multi-feel covers may equally be incorporated in other automotive trim assemblies.

With continuing reference to FIG. 1, the door trim panel 10 covers a portion of the interior of the automobile to provide a more aesthetically pleasing environment. Notably, the multi-feel of the armrest 12a and bolster 12b provides added comfort to the vehicle's occupants such as when the occupant chooses to rest an arm thereon and/or thereagainst. In addition, the armrest 12a further may include a handle portion 16 configured for grasping by a vehicle occupant to facilitate, for example, closing of a car door 18. A variety of openings, additionally, can be included in the trim panel 10 so as to accommodate the placement of hardware components 20 such as a speaker(s), door handle, window controls, etc.

As best shown in FIGS. 1 and 1A, the door panel 10 includes a substrate 24 having the integrated armrest 12a and bolster 12b, which may be made from a first material 26 that can include a thermoplastic polymer such as a thermoplastic olefin, e.g. polypropylene, or polycarbonate/acrylonitrile butadiene styrene. The door panel 10 further includes multi-feel covers 14a, 14b that are bonded, i.e. integrally molded, to at least a portion of the armrest 12a and the bolster 12b, respectively, to define at least a first and a second thickness t₁ and t₂. The second thickness t₂ is greater than the first thickness t₁ to provide a multi-feel cover 14a, 14b, i.e. a softer feel at the second thickness t₂. It should be understood that the covers 14a, 14b may be provided over the entire armrest 12a or bolster 12b, as well as a portion of the armrest 12a or bolster 12b that is more or less than shown, to provide the armrest 12a and/or bolster 12b with the multi-feel. In addition, as indicated above, the armrest 12a and/or bolster 12b with molded cover 14a, 14b may be provided as a separate part from the door panel 10 for attachment thereto.

Notably, the covers 14a, 14b are composed of a second foamed material 30 that may include a foamed thermoplastic polymer such as a foamed thermoplastic elastomer or foamed polypropylene. The second foamed material 30 may be activated, or foamed, by a blowing agent, such as sodium bicarbonate and the like, any gas such as nitrogen, or any other commonly known blowing agent. More specifically, the blowing agent is combined, or mixed, with a thermoplastic polymer, such as a thermoplastic elastomer or polypropylene, advantageously a thermoplastic elastomer available from Kraiburg TPE, Corp. of Duluth, Ga., to produce the second foamed material 30. The blowing agent advantageously is present in an amount from 0.1% to 5% by weight of the mixture, more advantageously from 0.5% to 3% by weight. The foamed material produces the cover 14a, 14b that includes an outer skin 34 and a cellular inner core 36, within at least the second thickness t₂ of the cover 14a, 14b, such that the outer skin 34 will deform and compress the inner core 36 when a force is applied thereby providing a soft feel.

The feel of the cover 14a, 14b may be varied, or adjusted, to any desired softness by changing the thickness thereof. The second thickness t₂ of the cover 14a, 14b advantageously is at least 2 times greater, more advantageously about 5-8 times greater, most advantageously about 7 times greater than the first thickness t₁ of the cover. At a thickness of about 1.5 mm and less, the cover 14a, 14b defines an outer skin 34 but is substantially devoid of a soft inner core 36 because of an inability of the core 36 to be foamed. Notably, the first thickness t₁ of the cover 14a, 14b advantageously is about 1-3 mm, more advantageously about 1.5 mm, and the second thickness t₂ is about 5-12 mm, more advantageously about 6-8 mm. It should be understood that the transition between the first and second thickness may be sudden or gradual. In addition, a plurality of thicknesses may be provided by the cover 14a, 14b.

In another embodiment, as best shown in FIG. 1B, the trim assembly 10 includes a substrate 24 provided with a trim part, advantageously an integrated trim part, such as the integrated armrest 12a and bolster 12b, wherein the trim part 12a, 12b includes an outer surface 37 and a recessed area 39. A multi-feel cover 14a, 14b is integrally molded to at least a portion of the outer surface 37 to define the first thickness t₁ and further is integrally molded within the recessed area 39 to define the second thickness t₂. Accordingly, the second thickness t₂ is greater than the first thickness t₁ to provide a multi-feel cover 14a, 14b, i.e. a softer feel at the second thickness t₂.

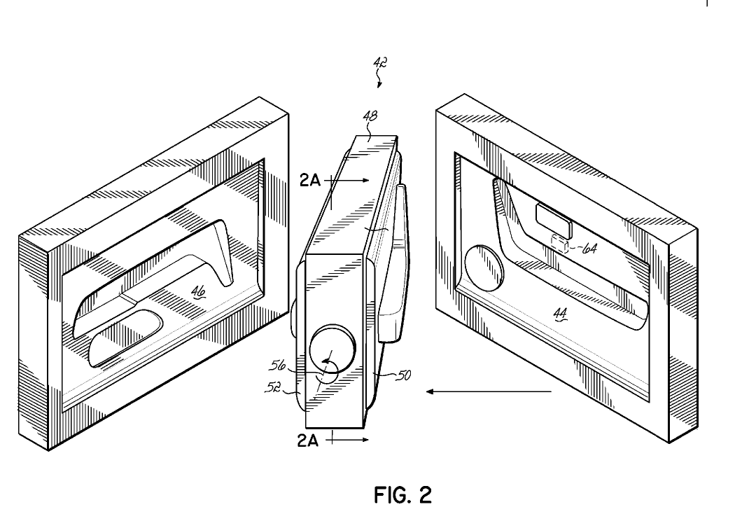

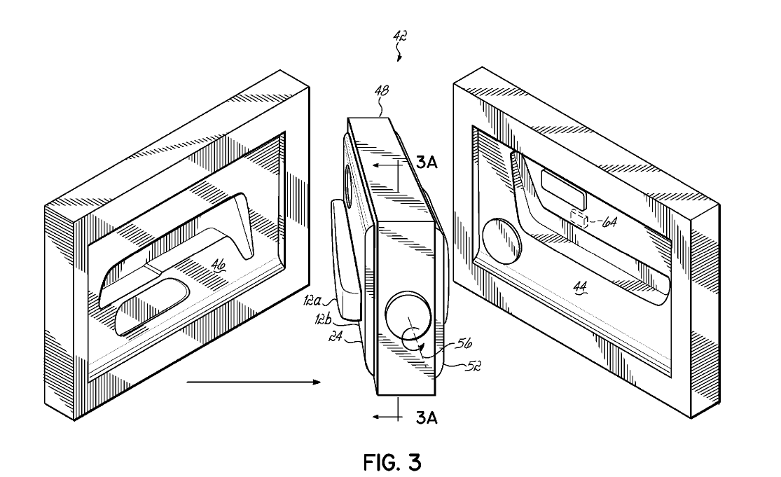

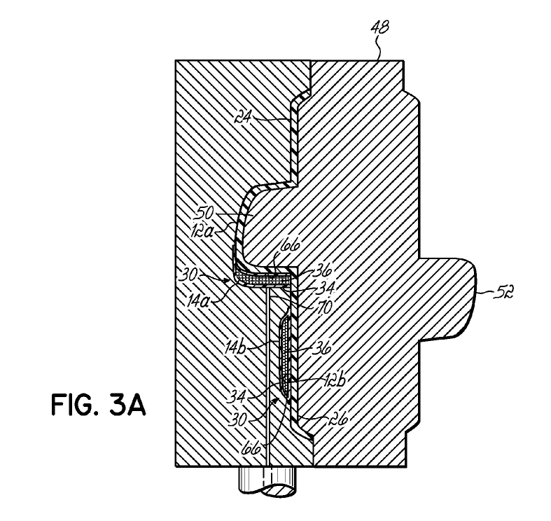

With reference to FIGS. 2-3A, a method of making the trim part, i.e. integrated armrest 12a and bolster 12b, with soft-feel of the present invention will now be described. As best shown in FIG. 2, a single mold assembly 42 includes spaced apart first and second shot mold cavities 44 and 46 and a central core 48 having first and second male portions 50 and 52 adapted to mate with each cavity 44, 46. The core is 48 situated between the mold cavities 44, 46 and is adapted to rotate about a central axis, i.e. a horizontal axis 56, so that the first and second male portions 50, 52 can mate, in turn, with the mold cavities 44, 46 to mold, in sequence, first the trim part 12a, 12b, advantageously the door trim panel 10 having the integrated trim part 12a, 12b, then the cover 28 in a continuous manner.

It should be understood by the artisan that variations of the mold assembly 42 may be provided and still fall within the scope of this invention. For example, any number of core male portions 50, 52 (i.e. more or less than shown) may be provided, in conjunction with the necessary number of corresponding first and second shot mold cavities 44, 46, for molding the door trim panel 10 having the armrest 12a and bolster 12b with multi-feel cover 14a, 14b.

While the first and second shots of the molding operation are further described below with respect to the first male portion 50 by utilizing the cross-sectional views of FIGS. 2 and 3, it is understood that the first and second shot molding process occurs in the same fashion with respect to the second male portion 52. Accordingly, as best shown in FIGS. 2 and 2A, the first male portion 50 of the core 48 mates with the first shot mold cavity 44 and, more specifically, the first shot mold cavity 44 is adapted to move toward the first male portion 50, as is commonly known in the art, to form a first shot chamber 60.

As further shown in FIGS. 2 and 2A, in a first shot of the molding operation, the first material 26, which may be a thermoplastic polymer such as a thermoplastic olefin, e.g. polypropylene, or polycarbonate/acrylonitrile butadiene styrene, is injected through a channel 62 into the chamber 60 to form the substrate 24 having the integrated armrest 12a and bolster 12b. Specifically, the molded substrate 24 is molded over the first male portion 50 such that the first male portion 50 retains the substrate 24. It should be understood, as indicated above, that the armrest 12a and/or bolster 12b may be molded as a separate part for later attachment to the door panel 10, or any other desired trim assembly, e.g. a console panel. A movable slide 64, as known in the art, is provided within the first shot mold cavity 44 to produce the handle 16, or pull-cup, portion for grasping by a vehicle occupant to facilitate the closing of the vehicle door 18. In addition, a variety of openings may be formed therein, by means known in the art, so as to accommodate the placement of hardware components 20 such as a speaker(s), door handle, window controls, etc.

With further reference to FIGS. 3 and 3A, the first shot mold cavity 44 is retracted, or moved away from, the first male portion 50, and the core 48 having the first male portion 50 provided with the substrate 24 then is rotated about the horizontal axis 56 to move the substrate 24 from the first shot mold cavity 44 to the second shot mold cavity 46. It should be understood that the core 48 also may rotate about a vertical axis or be adapted to move, or slide, sideways to a second shot mold cavity. Next, the first male portion 50 of the core 48 mates with the second shot mold cavity 46 and, more specifically, the second shot mold cavity 46 is adapted to move toward the first male portion 50, as is commonly known in the art, to form a second shot chamber 66 about at least a portion of armrest 12a and bolster 12b.

In a second shot of the molding operation, the second foamed material 30, which may be a foamed thermoplastic polymer such as a foamed thermoplastic elastomer or foamed polypropylene, is injected through a channel 70 (not shown for cover 14b) into the second shot chamber 66 to form the cover 14a, 14b. Notably, the cover 14a, 14b is bonded, or integrally molded, to at least the portion of the integrated armrest 12a and the bolster 12b. The cover 14a, 14b includes the first and second thickness t₁, t₂ wherein the second thickness t₂ is greater than the first thickness t₁ to provide the multi-feel cover 14a, 14b, i.e. a softer feel at the second thickness t₂ (See FIG. 1A).

As indicated above, the second foamed material 30 is activated, or foamed, by a blowing agent that can include sodium bicarbonate and the like, any gas such as nitrogen, or any other known blowing agent. More specifically, the blowing agent is combined, or pre-mixed, with a thermoplastic polymer, such as a thermoplastic elastomer or polypropylene, to form the second foamed material 30. Notably, the foamed material 30 produces the cover 14a, 14b that includes the outer skin 34 and the cellular inner core 36, within at least the second thickness t₂ of the cover 14a, 14b, such that the outer skin 34 will deform and compress the inner core 36 when a force is applied thereby providing a soft feel.

With specific reference to the trim assembly 10 shown in FIG. 1B, the substrate 24 may be molded in the first shot of the molding operation to provide the integrated armrest 12a and bolster 12b with the outer surface 37 and recessed area 39 so that the multi-feel cover 14a, 14b is integrally molded in the second shot of the molding operation to at least a portion of the outer surface 37 to define the first thickness t₁ and further is integrally molded within the recessed area 39 to define the second thickness t₂. It is understood that these trim parts 12a, 12b may be molded by the methods disclosed herein and also provided as a separate trim part for attachment to the door trim panel 10.

The multi-feel of the cover 14a, 14b may be varied, or adjusted, to any desired softness by changing the thickness thereof, such as by altering the depth of the second shot chamber 66 and/or by changing the depth of the recessed area 39. The second thickness t₂ of the cover 14a, 14b advantageously is at least 2 times greater, more advantageously about 5-8 times greater, most advantageously about 7 times greater than the first thickness t₁ of the cover 14a, 14b. At a thickness of about 1.5 mm and less, the cover 14a, 14b defines an outer skin 34 but is substantially devoid of a soft inner core 36 because of an inability of the core 36 to be foamed. Notably, the first thickness t₁ of the cover 14a, 14b advantageously is about 1-3 mm, more advantageously about 1.5 mm, and the second thickness t₂ is about 5-12 mm, more advantageously about 6-8 mm. It should be understood that the transition between the first and second thickness t₁, t₂ may be sudden or gradual. In addition, a plurality of thicknesses may be formed by the cover 14a, 14b.

With continuing reference to FIGS. 3 and 3A, after the second foamed material 30 has been allowed time sufficient to cure, the second shot mold cavity 46 is retracted, or moved away from, the first male portion 50, and the automotive interior trim assembly, i.e. the door trim panel 10, having the integrated armrest 12a and bolster 12b with multi-feel cover is ejected from the first male portion 50, such as by ejector pins (not shown), so that the process may begin anew. Although not illustrated, it is understood that the second male portion 52 also is adapted to mate with the first shot cavity 44, during the mating of the first male portion 50 with the second shot mold cavity 46, to form a second substrate (not shown) that may be identical to the first substrate 24 by injecting the first material 26 into the first shot mold cavity 44 in the first shot of the molding operation. After injection, the core 48 with the second male portion 52 similarly rotates the second substrate to the second shot mold cavity 46 for the second shot of the molding operation while the first male portion 50 returns to the first shot mold cavity 44 to repeat the first shot of the molding operation. In this fashion, a plurality of automotive interior trim assemblies 10 having integrated armrests 12a and bolsters 12b with multi-feel covers 14a, 14b may be formed in a continuous and efficient manner.

With reference again to FIG. 1, the molded trim panel assembly 10 includes the substrate 24 with integrated armrest 12a and bolster 12b, and cover 14a, 14b integrally molded respectively thereto and having first and second thickness t₁, t₂ (See. FIG. 1A) to provide a multi-feel. The trim assembly 10 now may be coupled, by means known in the art, to a doorframe structure 76 of a motor vehicle. Accordingly, the molding operation of the present invention may be continuously performed utilizing a single mold assembly 42 to provide an improved trim assembly 10 having a trim part, e.g. an integrated armrest 12a and bolster 12b, with a multi-feel cover 14a, 14b.

Although, the method of making utilizes a single mold assembly 42 for a continuous, integrated process, it still should be understood that the molding process may be performed in more than one mold assembly such that the trim part 12a, 12b may be moved from the first shot mold cavity 44 after the first shot to a second shot mold cavity 46 provided in a second, separate mold assembly (not shown) for the second shot of the molding operation. Movement can be manually or by other means commonly known in the art, e.g. robotically.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. An automotive interior trim assembly with multi-feel cover, comprising:
a substrate including an automotive trim part made from a first material; and
a cover made from a second foamed material, the cover being integrally molded to at least a portion of the trim part and defining a first and a second thickness, the second thickness being greater than the first thickness to provide a softer feel.

2. The automotive interior trim assembly of claim 1, wherein the trim part is selected from the group consisting of a bolster and an armrest.

3. The automotive interior trim assembly of claim 1, wherein the substrate includes an integrally molded trim part made from the first material.

4. The automotive interior trim assembly of claim 1, wherein the trim part includes an outer surface and a recessed area, the cover being integrally molded to at least a portion of the outer surface to define the first thickness and further being integrally molded within the recessed area to define the second thickness, the second thickness being greater than the first thickness to provide the softer feel.

5. The automotive interior trim assembly of claim 1 wherein the second thickness defines an outer skin and a soft inner core, and the first thickness defines an outer skin and is substantially devoid of a soft inner core.

6. The trim assembly of claim 1, wherein the first thickness is about 1-3 mm and the second thickness is about 5-12 mm to provide the softer feel.

7. The automotive interior trim assembly of claim 1, wherein the first material includes a thermoplastic polymer and the second foamed material includes one of a foamed thermoplastic elastomer and a foamed polypropylene.

8. A method of forming an automotive trim part having a multi-feel cover in a continuous two-shot molding operation, comprising:
providing a mold assembly having first and second shot mold cavities;
molding an automotive trim part by injecting a first material into the first shot mold cavity of the mold assembly in a first shot of the molding operation;
moving the trim part from the first shot mold cavity to the second shot mold cavity by using at least a portion of the mold assembly;
forming a mold chamber about at least a portion of the trim part within the second shot mold cavity of the mold assembly; and
molding a cover by injecting into the mold chamber a second foamed material in a second shot of the molding operation, the cover being molded to the at least a portion of the trim part and defining a first and a second thickness, the second thickness being greater than the first thickness to provide a softer feel.

9. The method of claim 8, wherein the step of molding an automotive trim part comprises molding the trim part selected from the group consisting of a bolster and an armrest.

10. The method of claim 8, wherein the step of molding a trim part comprises molding a substrate having an integrated trim part; and wherein the step of moving a trim part comprises moving the substrate having the integrated trim part from the first shot mold cavity to the second shot mold cavity by using the at least a portion of the mold assembly to mold the cover to the at least a portion of the trim part to define the first and second thicknesses.

11. The method of claim 8, wherein the step of molding a trim part comprises molding the trim part having an outer surface and a recessed area; wherein the step of forming a mold chamber comprises forming the mold chamber about the recessed area and at least a portion of the outer surface within the second shot mold cavity of the mold assembly; and wherein the step of molding the cover comprises molding the cover by injecting into the mold chamber the second foamed material in the second shot of the molding operation, the cover being integrally molded to the at least a portion of the outer surface to define the first thickness and being molded within the recessed area to define the second thickness, the second thickness being greater than the first thickness to provide the softer feel.

12. The method of claim 8, wherein the step of molding a cover comprises molding the cover so that the first thickness is about 1-3 mm and so that the second thickness is about 5-12 mm to provide the softer feel.

13. The method of claim 8, wherein the first material includes a thermoplastic polymer and the second foamed material includes one of a foamed thermoplastic elastomer and foamed polypropylene.

14. The method of claim 8, wherein the step of providing a mold assembly having first and second shot mold cavities comprises providing a mold assembly having first and second shot mold cavities and a core having at least one male portion adapted to mate with each cavity, the core further being adapted to rotate;
wherein the step of molding a trim part comprises molding the trim part by mating the at least one male portion with the first shot mold cavity and injecting the first material into the first shot mold cavity in the first shot of the molding operation;
wherein the step of moving a trim part comprises rotating the trim part on the at least one male portion of the core from the first mold cavity to the second mold cavity; and
wherein the step of forming a mold chamber comprises forming the mold chamber about at least a portion of the trim part within the second shot mold cavity of the mold assembly by mating the at least one male portion with the second shot mold cavity to mold the cover in the second shot of the molding operation.

15. A method of forming an automotive trim part having a multi-feel cover in a two-shot molding operation, comprising:
molding an automotive trim part by injecting a first material in a first shot of the molding operation;
forming a mold chamber about at least a portion of the trim part; and
molding a cover by injecting into the mold chamber a second foamed material in a second shot of the molding operation, the cover being molded to the at least a portion of the trim part and defining a first thickness a second thickness, the second thickness being greater than the first thickness to provide a softer feel.

16. The method of claim 15, wherein the step of molding an automotive trim part comprises molding the trim part selected from the group consisting of a bolster and an armrest.

17. The method of claim 15, wherein the first material includes a thermoplastic polymer and the second foamed material includes a foamed thermoplastic elastomer or foamed polypropylene.

18. The method of claim 15, wherein the step of molding a cover comprises molding the cover so that the first thickness is about 1-3 mm and so that the second thickness is about 5-12 mm to provide the softer feel.

19. The method of claim 15, wherein the step of molding a trim part comprises molding a substrate having an integrated trim part.

20. The method of claim 15, wherein the step of molding a trim part comprises molding the trim part having an outer surface and a recessed area; wherein the step of forming a mold chamber comprises forming the mold chamber about the recessed area and at least a portion of the outer surface within the second shot mold cavity of the mold assembly; and wherein the step of molding the cover comprises molding the cover by injecting into the mold chamber the second foamed material in the second shot of the molding operation, the cover being integrally molded to the at least a portion of the outer surface to define the first thickness and being molded within the recessed area to define the second thickness, the second thickness being greater than the first thickness to provide the softer feel.
